(19) United States
(12) Patent Application Publication
(10) Pub. No.: US 2022/0321564 A1
(43) Pub. Date: Oct. 6, 2022

(54) RESOURCE PAYLOAD COMMUNICATIONS

(71) Applicant: Hewlett-Packard Development Company, L.P., Spring, TX (US)

(72) Inventors: Travis M. Cossel, Boise, ID (US); Russuel Wood, Boise, ID (US); Shubhashree Venkatesh, Vancouver, WA (US)

(21) Appl. No.: 17/221,397

(22) Filed: Apr. 2, 2021

(51) Int. Cl. H04L 29/06

(52) U.S. Cl. CPC H04L 63/10; H04L 63/029; H04L 63/08

(57) ABSTRACT

In some examples, a computing device can include a processor resource and a non-transitory memory resource storing machine-readable instructions stored thereon that, when executed, cause the processor resource to: send, by a first service, a first signal to a first resource that is separated by a network security solution utilizing a first communication path, send, by a second service, the first signal with a first payload to a second resource that is separated by the network security solution utilizing a second communication path, receive, by the second service, a second signal with a second payload from the second resource through the second communication path in response to the first signal, and send, by the second service, instructions related to the second payload to the first service to execute the instructions.

### BACKGROUND

A computing device can allow a user to utilize computing device operations for work, education, gaming, multimedia, and/or other uses. Computing devices can be utilized in a non-portable setting, such as at a desktop, and/or be portable to allow a user to carry or otherwise bring the computing device along while in a mobile setting. These computing devices can be communicatively coupled to other computing devices and/or computing resources to perform particular functions.

### BRIEF DESCRIPTION OF THE DRAWINGS

FIG. 1 illustrates an example of a computing device for resource payload communications.

FIG. 2 illustrates an example of a memory resource storing instructions for resource payload communications.

FIG. 3 illustrates an example of a system including a computing device for resource payload communications.

FIG. 4 illustrates an example of a system for resource payload communications.

FIG. 5 illustrates an example of a system for resource payload communications.

### DETAILED DESCRIPTION

A user may utilize a computing device for various purposes, such as for business and/or recreational use. As used herein, the term computing device refers to an electronic system having a processor resource and a memory resource. Examples of computing devices can include, for instance, a laptop computer, a notebook computer, a desktop computer, an all-in-one (AlO) computer, networking device (e.g., router, switch, etc.), and/or a mobile device (e.g., a smart phone, tablet, personal digital assistant, smart glasses, a wrist-worn device such as a smart watch, etc.), among other types of computing devices. As used herein, a mobile device refers to devices that are (or can be) carried and/or worn by a user.

In some examples, the computing device can be communicatively coupled to a different computing device and/or computing resource. As used herein, a computing resource refers to a computing device or computing system that performs particular computing functions associated with a computing device or for a computing device. For example, a computing resource can be a cloud resource, server device, or other system that can be utilized to perform a particular service associated with the computing device. In some examples, the computing device and the computing resource can be part of the same device. In other examples, the computing device and the computing resource can be separate or distinct devices that can be communicatively coupled through a communication path or network. As used herein, communicatively coupled devices refer to devices that can communicate through a communication path.

In some examples, the communication path or network that couples the computing device with the computing resource can include a network security solution. As used herein, a network security solution can include a system, device, or method for protecting data transmitted across a communication path or network. For example, a network security solution can include, but is not limited to: a firewall, a proxy, a network address translation (NAT), or other type of network security application. In some examples, the network security solution can prevent particular types of communication from being received by the computing device and/or a computing resource associated with the computing device. For example, a network security solution may prevent a computing resource from sending unsolicited callback signals to the computing device or prevent unauthorized users from accessing the computing device. In this way, a computing device that was previously utilized as an enterprise device with the computing device and computing resource being local, may have communication issues when expanded to a device that separates the computing device from the computing resource using a network security solution.

The present disclosure relates to resource payload communication implementations that can be utilized to allow a computing resource or agent of a computing resource to send unsolicited call back requests to a computing device or particular service of a computing device without the computing device or service of the computing device establishing a bidirectional communication socket with the computing resource or a particular agent of the computing resource. In this way, the callback requests that are sent or received by a particular service of the computing device can be maintained whether the computing device is operating in an enterprise or network environment with a particular computing resource. In this way, the computing device can maintain backwards compatibility with other components of the device.

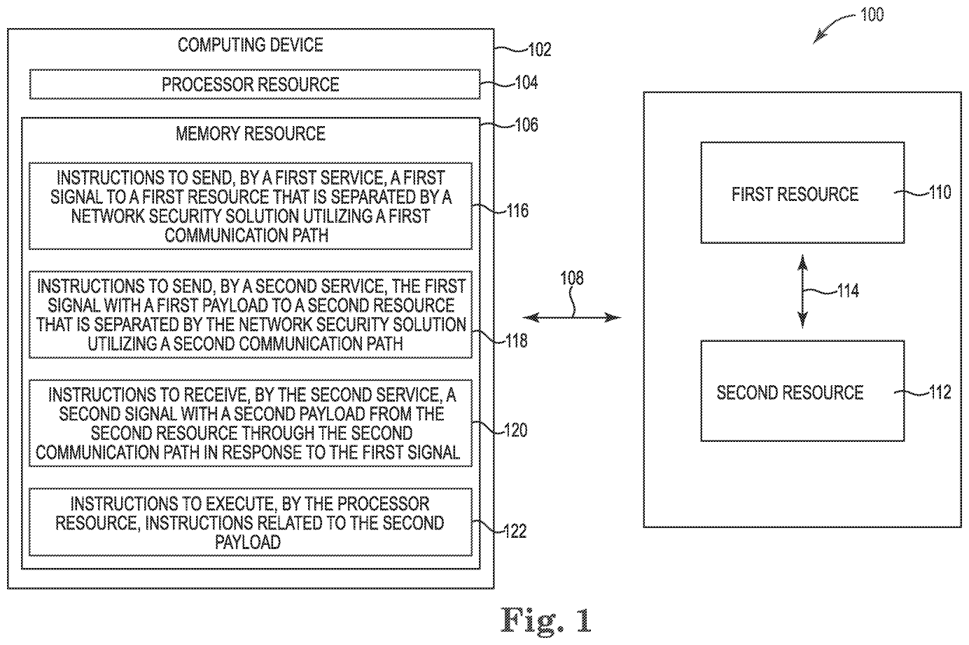

FIG. 1 illustrates an example of a computing device 102 for resource payload communications. In some examples the computing device 102 can include a processor resource 104 communicatively coupled to a memory resource 106. As described further herein, the memory resource 106 can include instructions 116, 118, 120, 122 that can be executed by the processor resource 104 to perform particular functions. In some examples, the computing device 102 can be associated with a printing device and/or imaging device (e.g., camera, scanner, optical sensor, etc.). In some examples, the computing device 102 can be part of a printing device or imaging device that can include an interface that can be utilized by a user at the printing device. For example, the computing device 102 can include a user interface to authenticate a human user at the computing device 102. In another example, the computing device 102 can include a communication port that can be utilized to connect peripheral devices to the computing device 102. In this way, a user can perform particular actions at the computing device 102.

The computing device 102 can include components such as a processor resource 104. As used herein, the processor resource 104 can include, but is not limited to: a central processing unit (CPU), an application specific integrated circuit (ASIC), a field programmable gate array (FPGA), a metal-programmable cell array (MPCA), a semiconductor-based microprocessor, or other combination of circuitry and/or logic to orchestrate execution of instructions 116, 118, 120, 122. In other examples, the computing device 102 can include instructions 116, 118, 120, 122, stored on a machine-readable medium (e.g., memory resource 106, non-transitory computer-readable medium, etc.) and executable by a processor resource 104. In a specific example, the computing device 102 utilizes a non-transitory computer-readable medium storing instructions 116, 118, 120, 122, that, when executed, cause the processor resource 104 to perform corresponding functions.

In some examples, the computing device 102 can include instructions 116 to send, by a first service, a first signal to a first resource 110 that is separated by a network security solution utilizing a first communication path (e.g., first communication socket, etc.). In some examples, the processor resource 104 of the computing device 102 can execute different services including a first service and a second service. In some examples, the different services can comprise instructions that can be executed by the processor resource 104 to perform a corresponding function. For example, the first service can include instructions for performing a particular function at a device and the second service can include instructions for performing a separate function. In some examples, the first service can correspond to a feature or function of a device associated with the computing device 102. For example, the first service can respond to functions of a peripheral port (e.g., universal serial bus (USB) port, etc.) of a printing device associated with the computing device 102. In this way, when a peripheral device is plugged into the peripheral port, the first service can perform a particular function in response.

In some examples, the first service can include instructions executed by the processor resource 104 to send the first signal to the first resource 110 in response to a particular action performed on a device associated with the computing device 102. In some examples, the first signal can be a callback signal that is transmitted by a first service in response to the particular action performed on the device. As used herein, a callback signal can include executable instructions that is transmitted as an argument to be executed at a particular time. In some examples, the first service can transmit the first signal to the first resource 110 through a communication path 108 or through an established socket utilizing the communication path 108. As used herein, a communication path 108 can be a wired or wireless connection that allows signals to be transmitted. In some examples, the first service can be separated from the first resource 110 by a network security solution (e.g., firewall, proxy, NAT, etc.). In some examples, the network security solution can prevent the first resource 110 from sending unsolicited signals to the first service or computing device 102. As used herein, a resource can include instructions that can be executed to perform a particular function as part of a computing service (e.g., application, etc.). In other examples, the established socket of the first service in combination with the network security solution can prevent the first resource 110 from sending unsolicited signals to the first service or computing device 102.

In some examples, the computing device 102 can include instructions 118 to send, by a second service, the first signal with a first payload to a second resource 112 that is separated by the network security solution utilizing a second communication path (e.g., second communication socket, etc.). In some examples, the second service can receive an indication or instruction signal from the first service that the first service sent the first signal to the first resource 110. In these examples, the second service can send the first signal with a first payload to a second resource 112 utilizing the second communication path. In some examples, the second communication path can be a second socket that is established by the second service over the communication path 108. In some examples, the first payload can include instructions for the second resource 112 that the first resource 110 can send unsolicited signals to the second service utilizing the second communication path. In some examples, the first communication path and the second communication path can be established utilizing different communication sockets that can define the type of communication that can be transmitted or received.

As used herein, a communication socket or network socket refers to instructions associated with sending and receiving data over a communication path or network. In some examples, a communication socket can include instructions to allow for bidirectional communication such that the sending device and/or receiving device are allowed to provide unsolicited communication. In other examples, a communication socket can include instructions to allow for mono-directional communication such that a first device can send unsolicited communication to a second device while the second device may be restricted from sending unsolicited communication to the first device.

In some examples, the first service can establish a first socket that is a mono-directional socket for the first communication path such that the first service can send unsolicited signals to the first resource 110, but the first resource 110 is not able to send unsolicited signals to the first service. In another example, the second service can establish a second socket that is a bidirectional socket for the second communication path such that the second service and/or the second resource 112 can send unsolicited signals through the second communication path. That is, in some examples, a first communication path can establish a first type of communication socket that is mono-directional and a second communication path can establish a second type of communication socket that is bidirectional. In this way, as described further herein, the second resource 112 can send unsolicited callback or callrequest signals to the second service on behalf of the first resource 110.

In some examples, the second service can establish a network socket to provide a non-permanent communication path with the second resource 112 (e.g., second agent, etc.) of the resource through the network security solution. As described herein, a non-permanent communication path can include a communication path that does not permanently bypass the network security solution, which can decrease security of the computing device 102. In this way, the computing device 102 can establish a communication session for a period of time without decreasing security or decrease the capability of the network security solution.

In some examples, the computing device 102 can include instructions 120 to receive, by the second service, a second signal with a second payload from the second resource 112 through the second communication path in response to the first signal. In some examples, the second resource 112 can respond to the first signal and/or the first payload with the second signal and/or second payload through the second communication path. As described herein, the second communication path can be established with a bidirectional socket between the second service and the second resource 112 such that the second resource 112 can send the second signal and/or the second payload as an unsolicited signal. In some examples, the second signal and/or the second payload can be sent in response to an instruction signal provided to the second resource 112 by the first resource 110. For example, the first resource 110 can receive the first signal from the first service and generate a response to the first signal. In this example, the first resource 110 can determine that the first communication path was established with a mono-directional socket and an unsolicited signal is not capable of being transmitted to the first service through the first communication path. In this example, the first resource 110 can send a signal, utilizing a communication path 114, that includes the response to the first signal (e.g., second signal, second payload, etc.) with an instruction that the second resource 112 send the response to the second service through the second communication path. In this example, the communication path 114 may not include a network security solution or other system that prevents the first resource 110 from sending unsolicited signals to the second resource 112.

In some examples, the computing device 102 can include instructions 122 to execute, by the processor resource 104, instructions related to the second payload. In some examples, the second service can send the second payload and/or instructions related to the payload to a different service to be executed by the computing device 102. In some examples, the computing device 102 can include instructions to send, by the second service, instructions related to the second payload to the first service to execute the instructions. In this way, the first resource 110 can provide unsolicited signals to the computing device 102 even though the first communication path was established with the first socket that is a mono-directional socket. In addition, this allows the first service to maintain backwards compatibility since changes to the instructions for responding to a particular action or function that results in sending the first signal does not have to be changed or altered to accommodate the network security solution.

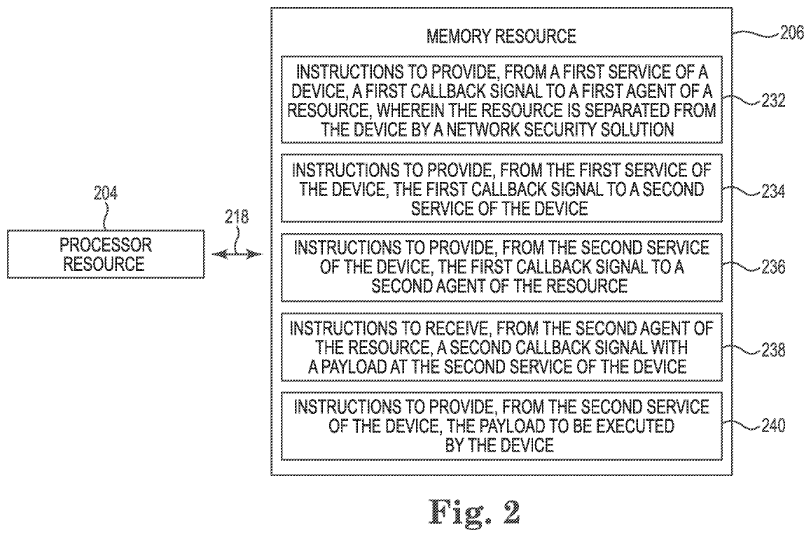

FIG. 2 illustrates an example of a memory resource 206 storing instructions for resource payload communications. In some examples, the memory resource 206 can be a part of a computing device or controller that can be communicatively coupled to a computing system that includes image capture devices. For example, the memory resource 206 can be part of a computing device 102 as referenced in FIG. 1 and communicatively coupled to an image capture device. In some examples, the memory resource 206 can be communicatively coupled to a processor resource 204 that can execute instructions 232, 234, 236, 238, 240 stored on the memory resource 206. For example, the memory resource 206 can be communicatively coupled to the processor resource 204 through a communication path 218. In some examples, a communication path 218 can include a wired or wireless connection that can allow communication between devices and/or components within a single device.

The memory resource 206 may be electronic, magnetic, optical, or other physical storage device that stores executable instructions. Thus, a non-transitory machine readable medium (MRM) (e.g., a memory resource 206) may be, for example, a non-transitory MRM comprising Random-Access Memory (RAM), read-only memory (ROM), an Electrically-Erasable Programmable ROM (EEPROM), a storage drive, an optical disc, and the like. The non-transitory machine readable medium (e.g., a memory resource 206) may be disposed within a controller and/or computing device. In this example, the executable instructions 232, 234, 236, 238, 240 can be “installed” on the device. Additionally, and/or alternatively, the non-transitory machine readable medium (e.g., a memory resource) can be a portable, external or remote storage medium, for example, that allows a computing system to download the instructions 232, 234, 236, 238, 240 from the portable/external/remote storage medium. In this situation, the executable instructions may be part of an “installation package”. As described herein, the non-transitory machine readable medium (e.g., a memory resource 206) can be encoded with executable instructions for selecting an output resolution for a particular captured document.

The instructions 232, when executed by a processor resource such as the processor resource 204, can include instructions to provide, from a first service of a device, a first callback signal to a first agent of a resource, wherein the resource is separated from the device by a network security solution. As described herein, a device (e.g., printing device, computing device, etc.) that includes the memory resource 206 and/or processor resource 204 can include a plurality of services to provide corresponding functions. The plurality of services can utilize corresponding instructions that can be executed by the processor resource 204 to perform the corresponding functions. In a similar way, the resource can be a computing device or computing server that provides a particular service to computing devices or other types of devices. For example, the resource can be a computing solution executed by a computing server. In some examples, the resource can include a plurality of agents that can perform corresponding functions. In some examples, the plurality of agents can each include instructions that can be executed by a processor resource.

In some examples, the first service of a device can provide the first callback signal to the first agent of the resource through a communication channel. In these examples, the communication channel can include a network security solution that separates the first service and the first agent. In some examples, the network security solution and/or socket established by the first service can prevent the first agent from sending unsolicited signals such as unsolicited callback signals or callrequest signals to the first service. In this way, the first agent may not be able to provide a callback or callrequest signal to the first service in response to the first callback signal.

The instructions 234, when executed by a processor resource such as the processor resource 204, can include instructions to provide, from the first service of the device, the first callback signal to a second service of the device. In some examples, the first service and the second service can be communicatively coupled to allow the first service to send signals to the second service. In these examples, the first service can send the first callback signal or an instruction signal to the second service to notify or provide a notification to the second service that the first service has sent the first callback signal to the first agent of the resource. In this way, the second service can send the first callback signal with a payload that includes instructions for the first agent to respond to the first service and/or instructions for the first agent to send unsolicited signals to the first service.

The instructions 236, when executed by a processor resource such as the processor resource 204, can include instructions to provide, from the second service of the device, the first callback signal to a second agent of the resource. In some examples, the second service of the device can establish a communication path with a bidirectional socket to allow the second service to transmit unsolicited signals to the second agent and allow the second agent to transmit unsolicited signals to the second service. In this way, the second service can provide the first callback signal to the second agent of the resource. In some examples, the second service can include instructions for establishing the bidirectional socket when the second service and the second agent were in an enterprise environment. In this way, the second service can remain unchanged from the enterprise environment and maintain backwards compatibility with a particular device.

As described herein, the second agent can send the first callback signal, first payload, and/or an instruction signal to the first agent. In some examples, the second agent of the resource can communicate with the first agent of the resource to determine the payload to be provided with a second callback signal or return callback signal. In these examples, the second agent can notify or provide a notification to the first agent that the first agent can provide unsolicited signals to the first service, second service, or other service associated with a particular device through the second agent. For example, the first agent can transmit a signal to the second agent to instruct the second agent to send a signal and/or payload to the second service. In this example, the second agent can send an unsolicited callback, callrequest, and/or other signal to the second service to allow the first agent to communicate with the second service and/or first service using unsolicited signals.

The instructions 238, when executed by a processor resource such as the processor resource 204, can include instructions to receive, from the second agent of the resource, a second callback signal with a payload at the second service of the device. As described herein, the second agent of the resource can generate a second callback signal with the payload based on a signal or instruction from the first agent. In this way, the second callback signal and/or the payload can be generated in response to an instruction by the first agent such that the first agent is able to provide the second callback signal and/or the payload to the second service. As described herein, the established socket between the first service and the first agent of the resource can prevent the first agent from sending unsolicited signals to the first agent. Altering the socket that is established by the first service can alter backwards compatibility within the device associated with the first service and thus may be avoided by utilizing the bidirectional socket that is established by the second service.

The instructions 240, when executed by a processor resource such as the processor resource 204, can include instructions to provide, from the second service of the device, the payload to be executed by the device. In some examples, the second service of the device can receive the payload from the second agent and provide the payload to a particular service to be executed by the device. For example, the second service can send the payload to the first service such that the first service can execute the payload and/or instructions associated with the payload. In some examples, the payload can correspond to instructions generated by the first agent to be communicated to the first service to instruct the first service to perform a particular function.

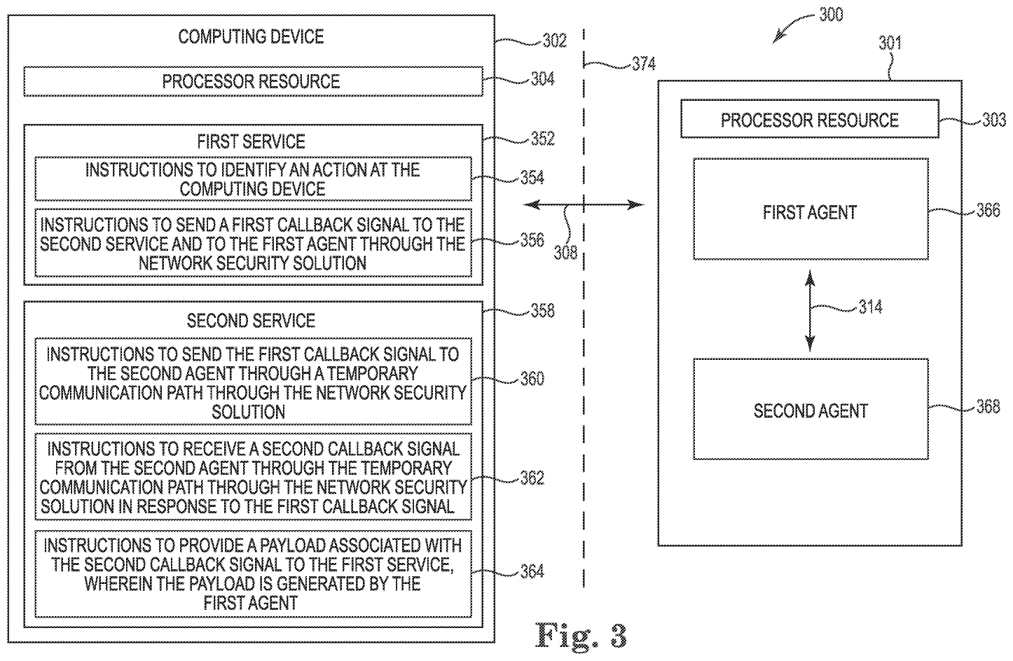

FIG. 3 illustrates an example of a system 300 including a computing device 302 for resource payload communications. In some examples the computing device 302 can be a device that includes a processor resource 304 communicatively coupled to a memory resource 306. As described herein, the memory resource 306 can include or store instructions 354, 356, 360, 362, 364, that can be executed by the processor resource 304 to perform particular functions.

In some examples, the computing device 302 can be communicatively coupled to a resource 301 using a communication path 308. The resource 301 can include a processor resource 303 that can be utilized to execute a first agent 366 and a second agent 368. As described herein, the first agent 366 can perform a first function and the second agent 368 can perform a second function. In some examples, the first agent 366 can be utilized to execute instructions to perform a first function or provide a particular response to instructions received from computing devices such as computing device 302. In some examples, the first agent 366 can communicate with the second agent 368 through a communication path 314. In some examples, the computing device 302 can be separated from the resource 301 by a network security solution 374 that can prevent some communication from being transmitted to the computing device 302. For example, the network security solution 374 can be a firewall that can block unauthorized access to the computing device 302.

In some examples, the computing device 302 can include a first service 352 and a second service 358. As described herein, the first service 352 can include instructions 354, 356 and/or other instructions that can be utilized to perform particular functions and the second service 358 can include instructions 360, 362, 364 and/or other instructions that can be utilized to perform different functions than the first service 352. In some examples, the first service 352 and the second service 358 can be communicatively coupled to allow the first service 352 to send signals to the second service 358.

In some examples, the computing device 302 can include a first service 352 that includes instructions 354 that can be executed by a processor resource 304 to identify an action at the computing device 302. In some examples, the action at the computing device 302 can include a user interacting with a component of the computing device 302. For example, the action at the computing device 302 can include, but is not limited to: coupling a peripheral device to a port of the computing device 302, providing identification credentials to the computing device 302, making a selection on a user interface of the computing device 302, among other types of interactions that can be performed at the computing device 302 or at the same physical location of the computing device 302. In some examples, the first service 352 can be a service or set of instructions that can be executed in response to the action being detected. For example, the first service 352 can initiate a communication with the first agent 366 in response to a detection that a peripheral memory device is coupled to a peripheral device port.

In some examples, the computing device 302 can include a first service 352 that includes instructions 356 that can be executed by a processor resource 304 to send a first callback signal to the second service 358 and to the first agent 366 through the network security solution 374. As described herein, the first service 352 can be programmed to provide the first callback signal in response to the action at the computing device 302 such that a corresponding agent would be provided with the first callback signal. As described herein, the first service 352 can be programmed to interact with an agent within the computing device 302. However, the first agent 366 in system 300 is separated by the network security solution 374 and not positioned within the computing device 302. In this way, the programming for the first service 352 can maintain the instructions for providing the first callback signal to the first agent 366, whether the first agent 366 is local or remote to the computing device 302.

In some examples, the computing device 302 can include a second service 358 that includes instructions 360 that can be executed by a processor resource 304 to send the first callback signal to the second agent 368 through a temporary communication path through the network security solution 374. As used herein, a temporary communication path can include a communication path that is established through a socket that can be utilized for a particular period of time. For example, the temporary communication path can establish a communication path between the second service 358 and the second agent 368 without bypassing the network security solution 374 or permanently bypassing the network security solution.

In some examples, the first service 352 can provide an instructional signal to the second service 358 in response to the first service 352 sending the first signal to the first agent 366. The instructional signal can include instructions to notify or provide a notification to the second service 358 to send the first callback signal and/or corresponding payload to the second agent 368. In some examples, the second service 358 can send the first callback signal and/or a corresponding payload to the second agent 368. In some examples, the first callback signal and/or corresponding payload can provide instructions to the second agent 368 for instructions to be provided to the first agent 366. In some examples, the second service 358 can establish a temporary communication path (e.g., communication session, etc.) with the second agent 368 through the communication path 308 that establishes a bidirectional socket with the second agent 368. In some examples, the bidirectional socket can allow the second agent 368 to provide unsolicited communication to the second service 358 through the network security solution 374.

In some examples, the computing device 302 can include a second service 358 that includes instructions 362 that can be executed by a processor resource 304 to receive a second callback signal from the second agent 368 through the temporary communication path through the network security solution 374 in response to the first callback signal. As described herein, the second agent 368 can provide a payload from the second service 358 to the first agent 366 to notify or provide a notification to the first agent 366 to send callback or callrequest signals to the second agent 368 such that the second agent 368 can provide the signals to the second service 358. In this way, the first agent 366 can provide unsolicited communication to the computing device 302 by utilizing the second agent 368.

In some examples, the computing device 302 can include a second service 358 that includes instructions 364 that can be executed by a processor resource 304 to provide a payload associated with the second callback signal to the first service 352, wherein the payload is generated by the first agent 366. As described herein, the first agent 366 can generate a callback signal or callrequest signal to the second agent 368 through the communication path 314. In this example, the second agent 368 can sent the generated callback signal or callrequest signal to the second service 358 through the communication path 308 and the second service 358 can provide a payload associated with the generated callback signal or callrequest signal to the first service 352 or other service of the computing device 302 to be executed. In this way, the first agent 366 can generate signals that can be provided to the computing device 302 when the first agent 366 is not authorized to provide signals through the network security solution 374.

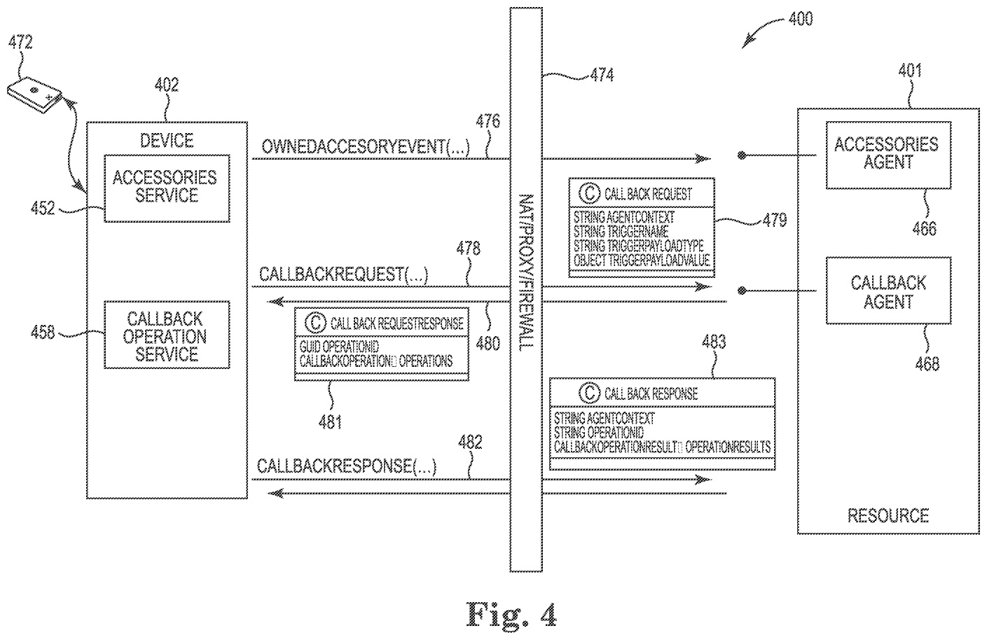

FIG. 4 illustrates an example of a system 400 for resource payload communications. The system 400 can illustrate one example of a method that can be performed using a system 400 for resource payload communications. The system 400 can include the same or similar elements as system 100 as referenced in FIG. 1 and/or system 300 as referenced in FIG. 3. For example, the system 400 can include a device 402 that is communicatively coupled to a resource 401 where a network security solution 474 separates the device 402 and the resource 401. The system 400 can illustrate a method of coupling a peripheral device 472 to the device 402.

In some examples, the device 402 can be a computing device that can include a processor resource that can execute instructions to perform particular functions. In some examples, the device 402 can include an accessories service 452 and a callback operation service 458 that can be executed to perform corresponding functions. In some examples, the system 400 can include a resource 401 that includes an accessories agent 466 and a callback agent 468. As described herein, the resource 401 can include a computing device, such as a server or similar device, that can include a processor resource to execute instructions stored on a memory resource to perform the functions associated with the accessories agent 466 and the callback agent 468.

In some examples, the device 402 can determine that a peripheral device 472 is coupled to a communication port of the device 402. For example, the device 402 can determine that a memory device is coupled to a USB portion of the device 402. In this example, the accessories service 452 can identify the action that a peripheral or accessory has been coupled to the device 402 and generate an “OwnedAccessoryEvent” signal and send the signal at 476 to notify the accessories agent 466 that the peripheral device 472 has been coupled to the device 402 and that the accessories agent 466 is to “own” or manage the peripheral device 472. In some examples, the accessories agent 466 can perform functions and/or send instructions associated with the peripheral device 472. For example, the accessories agent 466 can execute write operations and/or read operations on the peripheral device 472 when the peripheral device 472 is a memory resource.

In some examples, a first signal sent at 476 to the accessories agent 466 can be a permanent signal provided to the accessories agent 466 in response to an interaction with the device 402. As used herein, a permanent signal is a signal that is not able to be altered without affecting a backwards compatibility of the device 402. For example, the first signal sent at 476 can be a signal that is not editable or alterable in how the signal is generated in response to a particular event.

In some examples, the device 402 can establish a communication socket with the accessories agent 466 to send the “OwnedAccessoryEvent” signal at 476. As described herein, the socket established by the accessories service 452 can be a mono-directional socket that can allow the accessories service 452 to transmit unsolicited communication to the accessories agent 466, but may not allow the accessories agent 466 to transmit unsolicited communication to the accessories service 452 through the network security solution 474. In this way, the accessories agent 466 may not be able to send instructions directly to the accessories service 452 to perform functions associated with the peripheral device 472.

In some examples, the accessories agent 466 can notify the callback operation service 458 that the peripheral device 472 has been coupled to the device 402 and that the “OwnedAccessoryEvent” signal has been sent to the accessories agent 466. In some examples, the callback operation service 458 can send a “CallbackRequest” signal with a payload 479 to the callback agent 468. The “CallbackRequest” signal with the payload 479 can include instructions for notifying the callback agent 468 how the accessories agent 466 can provide instructions for performing functions associated with the peripheral device 472. For example, the payload 479 can include, but is not limited to: agent context, trigger name, trigger payload type, trigger payload value, among other information. In some examples, the payload 479 can be generated based on information received from the accessories service 452.

In some examples, the device 402 can encrypt the payload 479. In some examples, the callback operation service 458 can encrypt the payload 479 utilizing a hash-based message authentication code (HMAC) signature mechanism before sending the payload 479 to the callback agent 468. The callback operation service 458 can utilize a shared secret with the callback agent 468 to generate a HMAC signature that can be attached to the payload 479. The callback agent 468 can utilize the shared secret to decrypt the payload 479. The system 400 can utilzie the HMAC signature mechanism to increase the security between the device 402 and the resource 401.

In some examples, the callback agent 468 can communicate the payload 479 and/or information associated with the payload 479 to the accessories agent 466. In some examples, the accessories agent 466 can notify the callback agent 468 how to respond to the “CallbackRequest” signal with the payload 479 at 478. In some examples, the callback operation service 458 can establish a communication socket that is bidirectional can allow the callback operation service 458 to send unsolicited signals to the callback agent 468 and the callback agent 468 can send unsolicited signals to the callback operation service 458.

In some examples, the callback agent 468 can authorize the device 402 through a first signature attached to a first callback signal sent at 478 by the callback operation service 458. As described herein, a HMAC signature mechanism can be utilized by the system 400 to authorize the device 402 and/or authorize the resource 401. In these examples, callback operation service 458 can attach a signature to the “OwnedAccessoryEvent” signal and the callback agent 468 can authorize the device 402 utilizing the attached signature. In some examples, the callback operation service 458 can authorize the resource 401 through a second signature attached to a second callback signal at 480 by the callback agent 468. In this way, the device 402 can authenticate the resource 401 before executing the payload 481 or any payload received by the resource 401.

In some examples, the callback agent 468 can send a “CallbackRequestResponse” at 480 and a payload 481 to the callback operation service 458 in response to receiving the payload 479. In some examples, the payload 481 can include information and/or instructions to be executed by the device 402 and/or a particular service of the device 402. In some examples, the payload 481 can include operation identification (ID), callback operations, and/or instructions to be executed by the device 402. In some examples, the callback operation service 458 can receive the payload 481 and provide the payload 481 and/or instructions associated with the payload 481 to a particular service to be executed by the device 402.

In some examples, the callback operation service 458 can provide the payload 481 and/or instructions associated with the payload 481 to the accessories service 452 to be executed by the accessories service 452. In some examples, the accessories service 452 can execute the instructions of the payload 481 on the peripheral device 472. That is, in some examples, the payload 481 can include instructions generated by a first agent (e.g., accessories agent 466) to instruct a first service (e.g., accessories service 452) in responding to an action at a device 402. In this way, the payload 481 can be generated by the accessories agent 466 and/or generated in response to instructions from the accessories agent 466 and provided to the accessories service 452 without the accessories agent 466 being able to directly send unsolicited communication to the accessories service accessories service 452.

In some examples, the device 402 can execute the operation instructed by the payload 481. In these examples, the callback operation service 458 can send a “CallbackResponse” at 482 with a corresponding payload 483 to provide a confirmation that the operation was performed and/or the results of the operation. In some examples, the callback agent 468 can provide the confirmation and/or results to the accessories agent 466. In this way, the accessories agent 466 can instruct the device 402 to perform particular functions through callback operations without being able to provide unsolicited communication with the device 402.

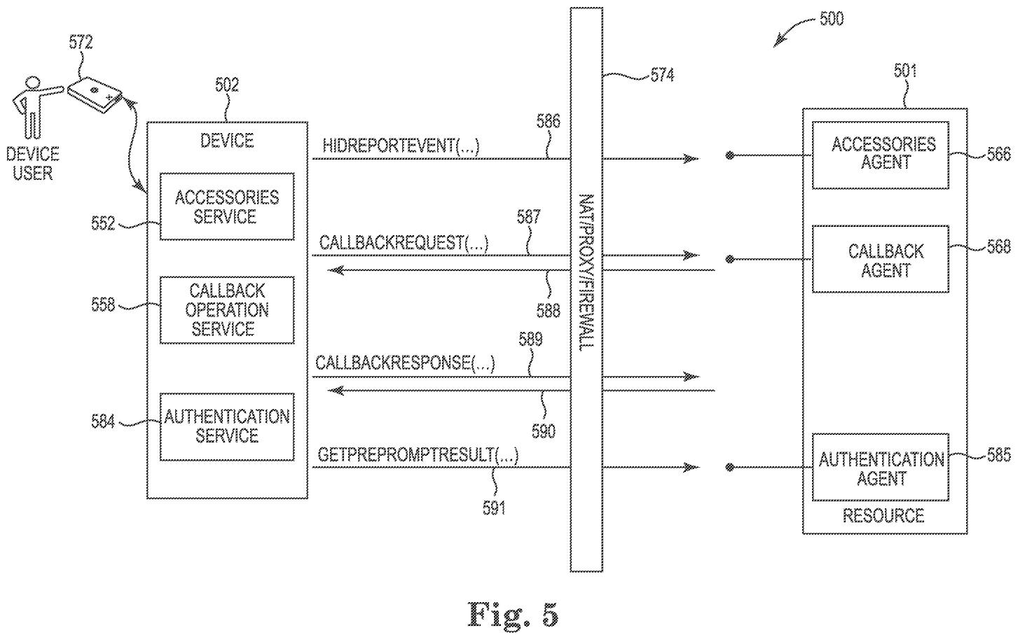

FIG. 5 illustrates an example of a system 500 for resource payload communications. The system 500 can illustrate one example of a method that can be performed using a system 500 for resource payload communications. The system 500 can include the same or similar elements as system 100 as referenced in FIG. 1, system 300 as referenced in FIG. 3, and/or system 400 as referenced in FIG. 4. For example, the system 500 can include a device 502 that is communicatively coupled to a resource 501 where a network security solution 574 separates the device 502 and the resource 501. The system 500 can illustrate a method of authenticating user credentials 572 at the device 502.

In some examples, the device 502 can be a computing device that can include a processor resource that can execute instructions to perform particular functions. In some examples, the device 502 can include an accessories service 552, a callback operation service 558, and/or an authentication service 584 that can be executed to perform corresponding functions. In some examples, the system 500 can include a resource 501 that includes an accessories agent 566, a callback agent 568, and/or an authentication agent 585. As described herein, the resource 501 can include a computing device, such as a server or similar device, that can include a processor resource to execute instructions stored on a memory resource to perform the functions associated with the accessories agent 566, the callback agent 468, and/or the authentication agent 585.

In some examples, the device 502 can determine that user credentials 572 are provided to the device 502. In some examples, the accessories service 552 can send a “HidReportEvent” signal at 586 to the accessories agent 566 in response to receiving the user credentials 572. As described herein, the network security solution 574 can prevent the accessories agent 566 from sending unsolicited communication to the device 502 and/or to the accessories service 552. In some examples, the callback operation service 558 can receive an indication from the accessories service 552 that the user credentials 572 were received at the device 502 and the “HidReportEvent” signal was sent at 586.

In some examples, the callback operation service 558 can send a “CallbackRequest” signal at 587 to the callback agent 568. The signal can include a payload with instructions for allowing the accessories agent 566 and/or the authentication agent 585 for providing unsolicited communication to the device 502. In some examples, the signal and/or payload sent at 587 can establish a bidirectional communication socket between the callback operation service 558 and the callback agent 568 such that the callback agent 568 can respond or send unsolicited signals to the callback operation service 558. In some examples, the callback agent 568 can respond to the “CallbackRequest” signal at 587 with a “CallbackRequestResponse” signal at 588. In some examples, the “CallbackRequestResponse” can include instructions for providing the user credentials 572 to the resource 501.

In some examples, the callback operation service 558 can provide the user credentials 572 through a “CallbackReponse” at 589 to the callback agent 568. In these examples, the callback agent 568 can provide the user credentials 572 to the authentication agent 585. The authentication agent 585 can process the user credentials 572 and provide the results of the process to the callback agent 568 to be sent back to the callback operation service 558 at 590. In some examples, the callback operation service 558 can send the process results of the authentication agent 585 to the authentication service 584. In some examples, the authentication service 584 can execute a particular process in response to the process results from the authentication agent 585. In some examples, the authentication service 584 can send a “GetPrePromptResults” signal at 591 to the callback agent 568 in response to executing the process results of the authentication agent 585.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure. Further, as used herein, “a” refers to one such thing or more than one such thing.

The figures herein follow a numbering convention in which the first digit corresponds to the drawing figure number and the remaining digits identify an element or component in the drawing. For example, reference numeral 102 may refer to element 102 in FIG. 1 and an analogous element may be identified by reference numeral 302 in FIG. 3. Elements shown in the various figures herein can be added, exchanged, and/or eliminated to provide additional examples of the disclosure. In addition, the proportion and the relative scale of the elements provided in the figures are intended to illustrate the examples of the disclosure and should not be taken in a limiting sense.

It can be understood that when an element is referred to as being “on,” “connected to”, “coupled to”, or “coupled with” another element, it can be directly on, connected, or coupled with the other element or intervening elements may be present. In contrast, when an object is “directly coupled to” or “directly coupled with” another element it is understood that are no intervening elements (adhesives, screws, other elements) etc.

The above specification, examples, and data provide a description of the system and method of the disclosure. Since many examples can be made without departing from the spirit and scope of the system and method of the disclosure, this specification merely sets forth some of the many possible example configurations and implementations.

What is claimed is:

1. A computing device, comprising:
a processor resource; and
a non-transitory memory resource storing machine-readable instructions stored thereon that, when executed, cause the processor resource to:
send, by a first service, a first signal to a first resource that is separated by a network security solution utilizing a first communication path;
send, by a second service, the first signal with a first payload to a second resource that is separated by the network security solution utilizing a second communication path;
receive, by the second service, a second signal with a second payload from the second resource through the second communication path in response to the first signal; and
execute, by the processor resource, instructions related to the second payload.

2. The computing device of claim 1, wherein the second service sends the instructions to the first service to execute the instructions related to the second payload.

3. The computing device of claim 1, wherein the first communication path establishes a first type of communication socket that is mono-directional and the second communication path establishes a second type of communication socket that is bidirectional.

4. The computing device of claim 1, wherein the processor resource is to provide an instructional signal to the second service in response to the first service sending the first signal to the first resource.

5. The computing device of claim 1, wherein the processor resource is to encrypt, by the second service, the first payload.

6. The computing device of claim 1, wherein the first signal sent to the first resource is a permanent signal provided to the first resource in response to an interaction with the computing device.

7. The computing device of claim 6, wherein the first payload includes a notification to be provided to the first resource by the second resource, wherein the notification indicates that the first service has sent the first signal to the first resource and to respond through the second service.

8. A non-transitory memory resource storing machine-readable instructions stored thereon that, when executed, cause a processor resource to:
provide, from a first service of a device, a first callback signal to a first agent of a resource, wherein the resource is separated from the device by a network security solution;
provide, from the first service of the device, the first callback signal to a second service of the device;
provide, from the second service of the device, the first callback signal to a second agent of the resource;
receive, from the second agent of the resource, a second callback signal with a payload at the second service of the device; and
provide, from the second service of the device, the payload to be executed by the device.

9. The memory resource of claim 8, wherein the second service establishes a network socket to provide a non-permanent communication path with the second agent of the resource through the network security solution.

10. The memory resource of claim 8, wherein the payload includes instructions to be executed by the first service of the device in response to the first callback signal.

11. The memory resource of claim 8, wherein the second agent of resource communicates with the first agent of the resource to determine the payload to be provided with the second callback signal.

12. A system, comprising:
a computing device comprising a processor resource to execute a first service and a second service;
a computing resource comprising a processor resource to execute a first agent and a second agent; and
a network security solution to provide network security for the computing device, wherein the network security solution restricts the first agent from sending unsolicited callback signals to the first service; wherein:
the first service identifies an action at the computing device;
the first service sends a first callback signal to the second service and to the first agent through the network security solution;
the second service sends the first callback signal to the second agent through a temporary communication path through the network security solution;
the second service receives a second callback signal from the second agent through the temporary communication path through the network security solution in response to the first callback signal; and
the second service provides a payload associated with the second callback signal to the first service, wherein the payload is generated by the first agent.

13. The system of claim 12, wherein the payload includes instructions generated by the first agent to instruct the first service in responding to the action at the computing device.

14. The system of claim 12, wherein the second agent is to authorize the device through a first signature attached to the first callback signal by the second service.

15. The system of claim 14, wherein the second service is to authorize the resource through a second signature attached to the second callback signal by the second agent.
